(19) United States
(12) Patent Application Publication
(10) Pub. No.: US 2020/0223346 A1
(43) Pub. Date: Jul. 16, 2020

(54) IMPROVED WET PLANT FOR A SAND MINE

(71) Applicant: Welch Aggregates, LLC, Magnolia, TX (US)

(72) Inventors: Paul A. Welch, Magnolia, TX (US); David E. Welch, Cleveland, TX (US)

(21) Appl. No.: 16/724,125

(22) Filed: Dec. 20, 2019

Related U.S. Application Data
(60) Provisional application No. 62/782,439, filed on Dec. 20, 2018.

(51) Int. Cl. B60P 1/36; B65D 88/12; B65G 67/24; B65G 65/46; B65G 65/42; B65G 37/00; B65G 15/08; B65G 23/00

(52) U.S. Cl. CPC B60P 1/36; B65D 88/124; B65D 88/129; B65G 67/24; B65G 23/00; B65G 65/42; B65G 37/00; B65G 15/08; B65G 65/466

(57) ABSTRACT

A wet sand delivery and conveyor apparatus ships wet proppant from a sand mine wet plant to a well fracturing site and delivers the wet proppant directly to the well site. The wet sand delivery and conveyor apparatus comprises a multi-container support frame, which is mounted on a trailer bed, a plurality of containers mounted to an upper portion of the frame, and a conveyor belt mounted on the frame below the plurality of containers and positioned to receive proppant released in a gravity pour from the containers onto the conveyor belt. An auger mounted near an end of the conveyor belt is also provided to transfer sand from the end of the trailer bed to a position extending diagonally upward and away from the trailer bed to drop sand into a vessel or sand deposit site positioned underneath an upper end portion of the auger.

### RELATED APPLICATIONS

This application claims the benefit of U.S. Provisional Patent Application No. 62/782,439, filed Dec. 20, 2018, and entitled “Improved Wet Plant for a Sand Mine.” This provisional application is herein incorporated by reference for all purposes.

### FIELD OF INVENTION

This invention is related to oil and gas mining, and more particularly, to proppants used in hydraulic fracturing.

### BACKGROUND

Hydraulic fracturing is a process to stimulate a natural gas, oil, or geothermal well to maximize extraction. It involves pumping pressurized fracturing fluid, such as water, into a wellbore to cause the pressure at the target depth to exceed the fracture gradient of the rock, causing the rock to crack. Typically, proppants such as sand, resin-coated sand, or grains of ceramic are pumped into the well with the fracturing fluid to “prop” the fractures in order to prevent the fractures from closing when the fracturing fluid is removed and enable the harvesting of natural gas or crude oil trapped in the formation. The propped fracture is permeable enough to allow the flow of gas, oil, saltwater and hydraulic fracturing fluids to the well.

The relatively recent use of hydraulic fracturing to stimulate oil and gas wells on the U.S.'s vast shale deposits has increased the demand for quality proppants that have optimal price, strength, sphericity, and other characteristics. Ceramic beads and resin-coated sand are frequently used as proppants. Sand, however, is the most commonly used and least expensive form of proppant. Raw sand must be processed to isolate grains having desirable proppant characteristics from grains and other substances having less desirable characteristics. This includes removing rocks, biomass, silt and dirt from the raw sand and screening the raw sand to separate a suitable range of grain sizes. Typically, sand grain sizes ranging from 8-mesh to 140-mesh, meaning that at least 90% of the proppant will pass through an 8-mesh sieve (where a sieve opening is 2.38 mm) and be retained by a 140 mesh sieve (where a sieve opening is 0.105 mm). However, the exact range of sizes suitable for fracking will depend on the specific needs of the oil or gas well site. Generally, the oil and gas industry demands fracturing sand that meets the American Petroleum Institute's (API's) recommended practices outlined in RP 19C, 56, 58, and 60, which are herein incorporated by reference.

A frac sand plant serves these needs. A frac sand plant typically comprises both a wet plant and a dry plant, both of which are built at or near a sand mining site. The wet plant washes the sand and removes silt, clay, rocks, biomass, and other impurities. The wet plant also substantially dewaters the sand using non-thermal mechanical techniques, but it doesn't completely dry it. The wet plant may also perform a rough sizing (one that is not to API spec) to separate out all potential sand that could be used in fracking. At the dry plant, the sand is dried, sized to spec, and stored in silos. After the sand is delivered to an oil or gas well site, it is blended with fracturing fluid (e.g., water) and injected into the well.

There are many reasons why fracking sand is shipped dry. Dry sand is traditionally easier to size according to customer requirements. Dry sand can be held in much larger storage containers without concerns of solidifying. Metering sand is much easier when the sand is completely dry. Shipping sand mixed with water is heavier than shipping dry sand, which raises transportation costs. Moist sand tends to cling to shipping carton surfaces more readily than dry sand, adding complexity to sand delivery operations. But shipping dry sand is not necessarily cheaper than shipping wet sand. A dry plant requires a large upfront capital investment and consumes large amounts of energy to dry wet sand.

### SUMMARY

It would be advantageous if a frac sand plant was made that eliminates the drying stage and that incorporates mechanisms for screening wet sand that can efficiently, effectively and reliably screen sand into proppants suitable for a hydraulic fracturing operation. There is also a need for an improved shipping container for wet proppant. Existing proppant containers have been designed for shipment and delivery of dry proppant. These typically use metal interior surfaces to which wet proppant is likely to stick and hatch and gate openings that are too small to efficiently (and with minimum waste) receive and dispense wet proppant. There is also a need for a modified proppant transportation and delivery rig for transporting the wet proppant and delivering it directly to the well, or a hopper or blender apparatus of the well, at an oil and gas site.

This application describes such a frac sand plant, such a proppant container, and such a transportation and delivery rig, as well as an improved auger design. The claims of this application are directed primarily to the transportation and delivery rig, the invention of which can stand on its own. Continuation applications are anticipated that will be primarily directed to the frac sand plant, proppant container, and auger design.

### BRIEF DESCRIPTION OF THE DRAWINGS

The present disclosure can be better understood with reference to the following figures. Corresponding reference numerals designate corresponding parts throughout the figures, and components in the figures are not necessarily to scale.

It will be appreciated that the drawings are provided for illustrative purposes and that the invention is not limited to the illustrated embodiment. For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings.

FIG. 1 is a functional block diagram illustrating different components and processing stages of a wet sand plant.

FIGS. 2A-2D are top left, top right, bottom left, and bottom right views, respectively, of another embodiment of a wet sand plant, the views when combined forming a diagram.

FIG. 3 illustrates one embodiment of a watering station.

FIG. 4 is a perspective view of one embodiment of a proppant container and frame assembly.

FIG. 5 is an exploded view of the proppant container and frame assembly embodiment of FIG. 4.

FIG. 6 is a perspective view of the proppant container of FIGS. 1 and 2.

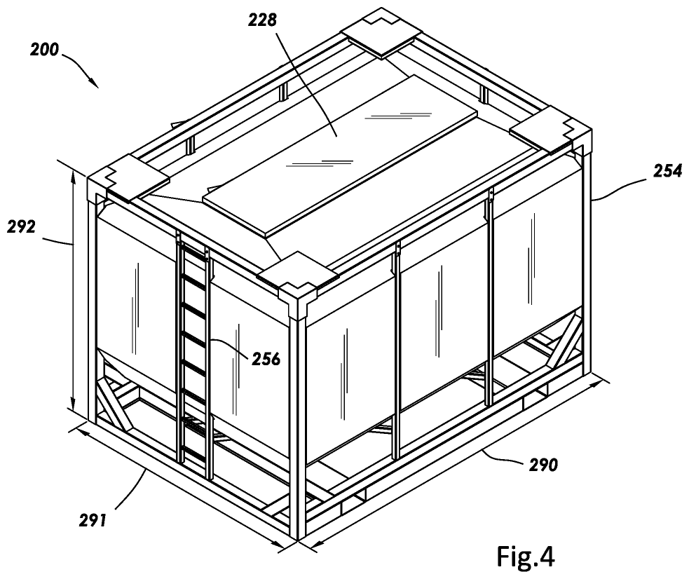

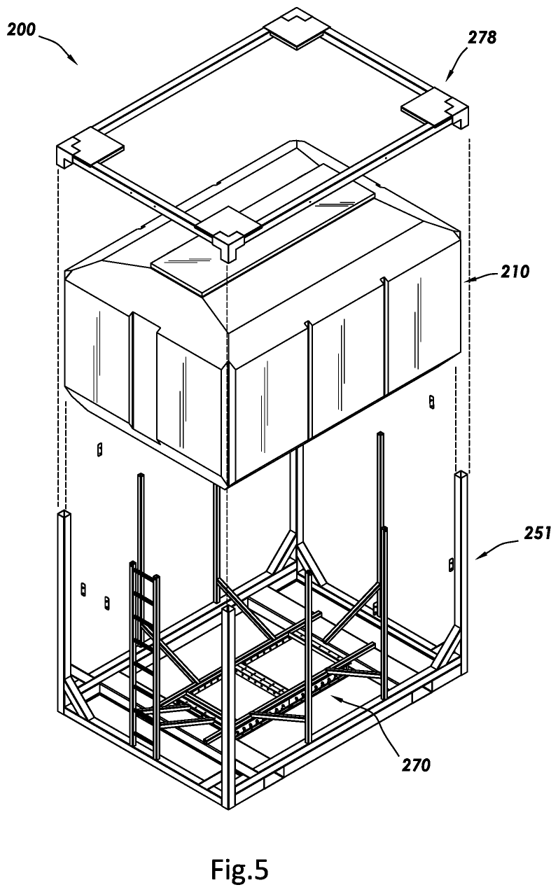

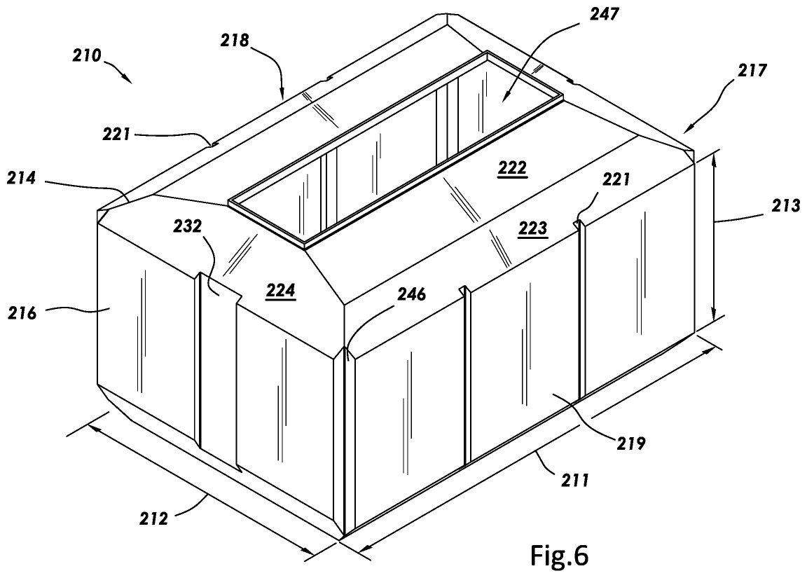

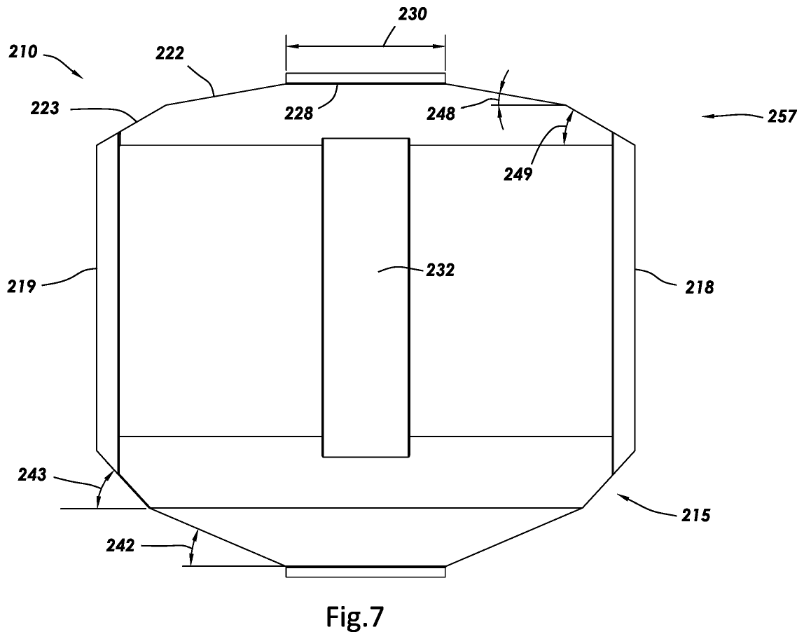

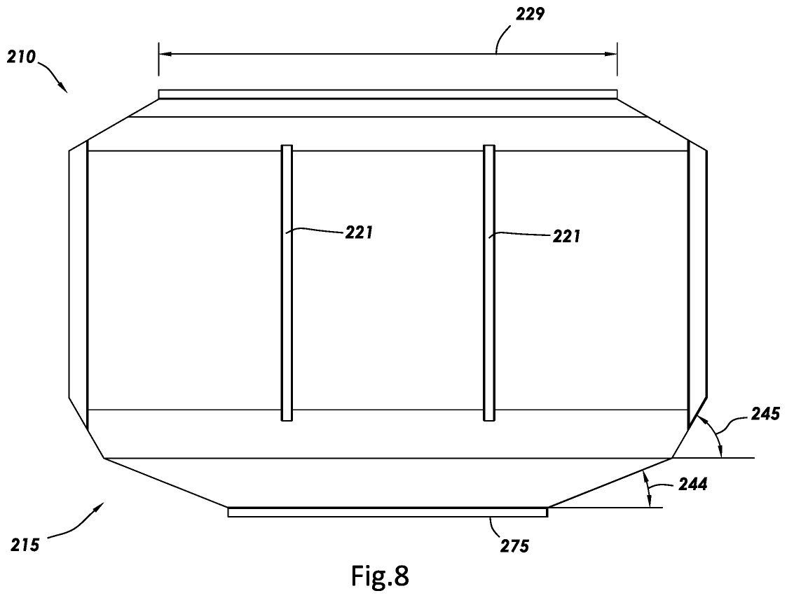

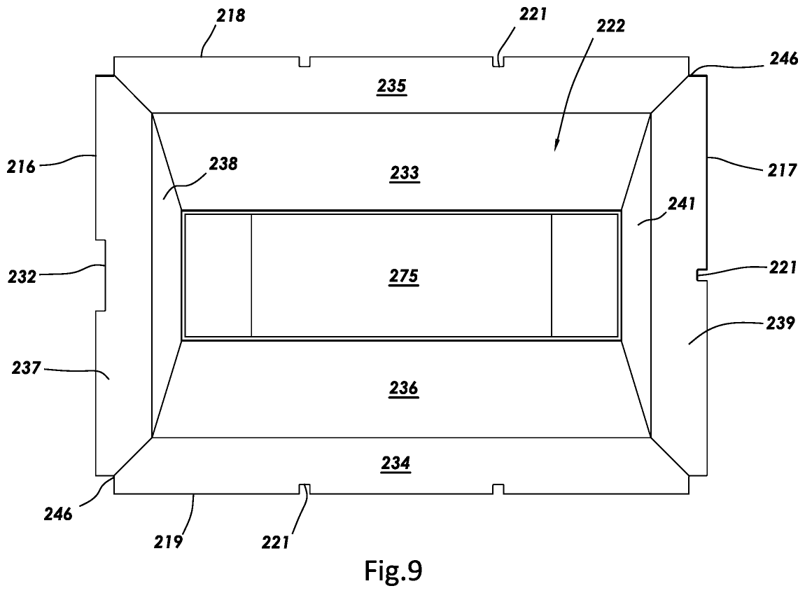

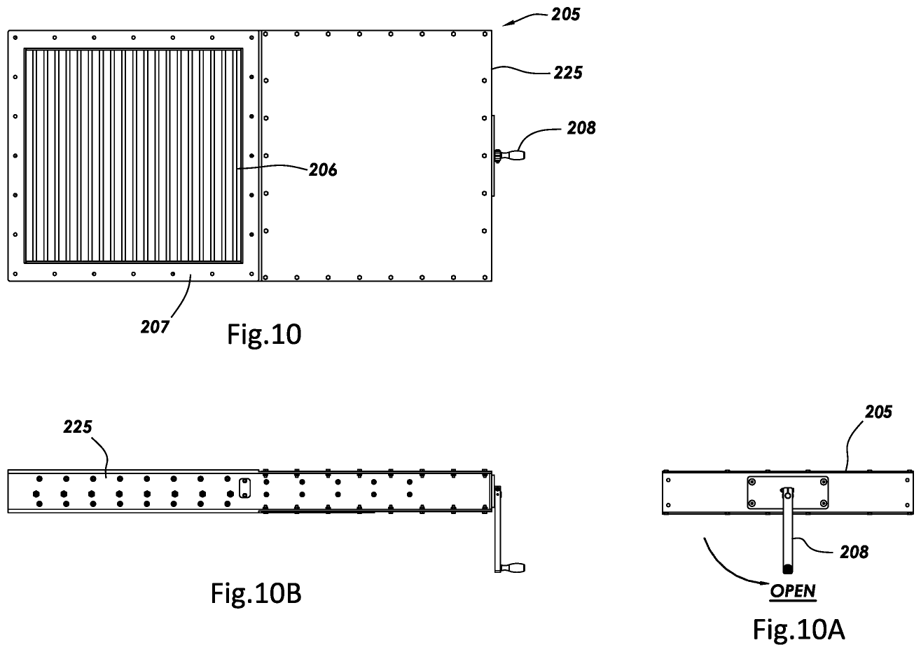

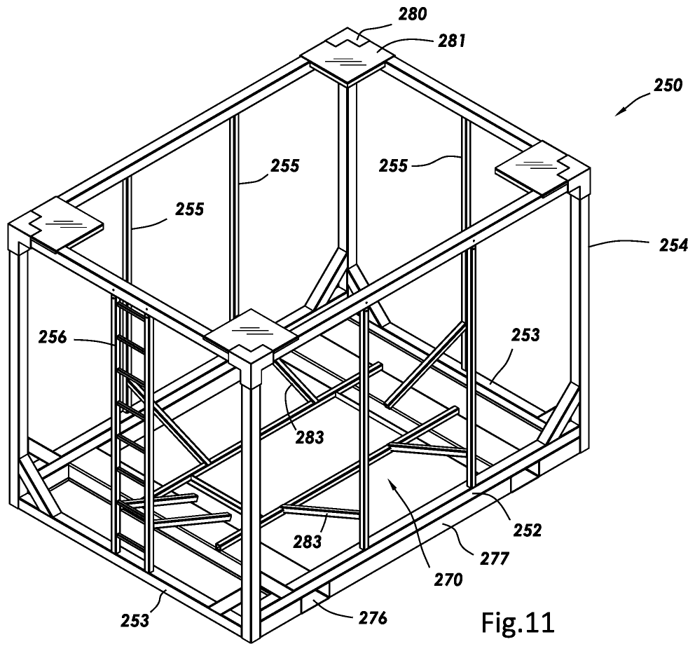

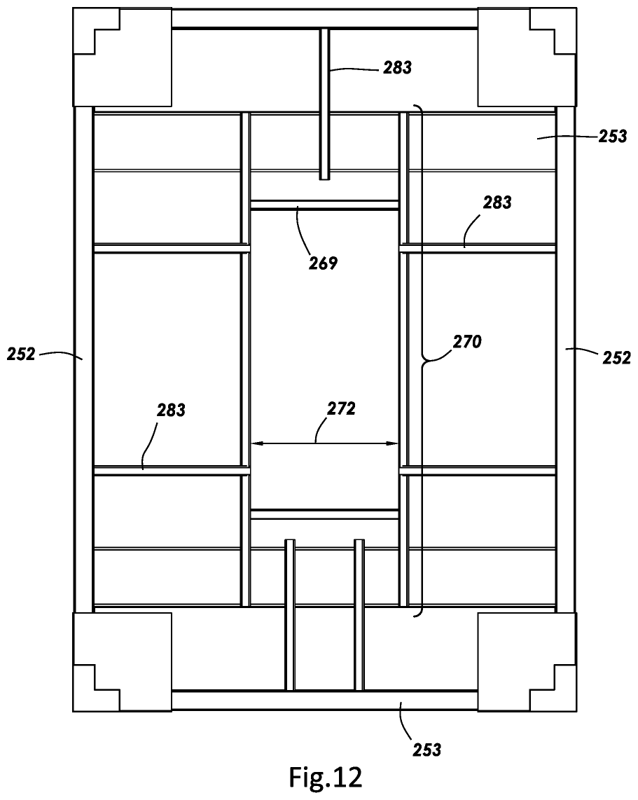

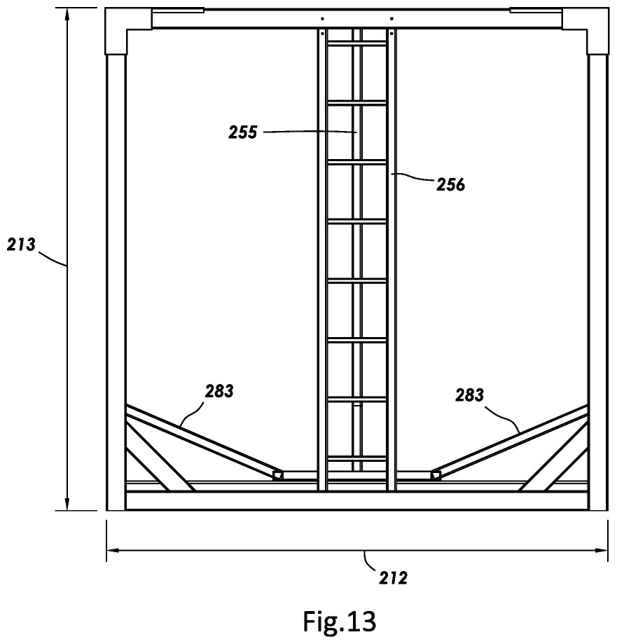

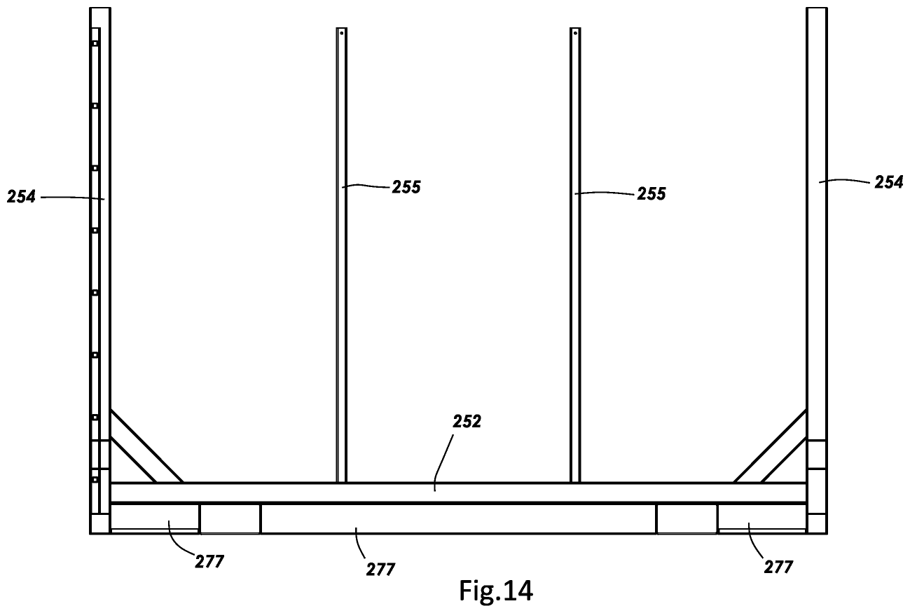

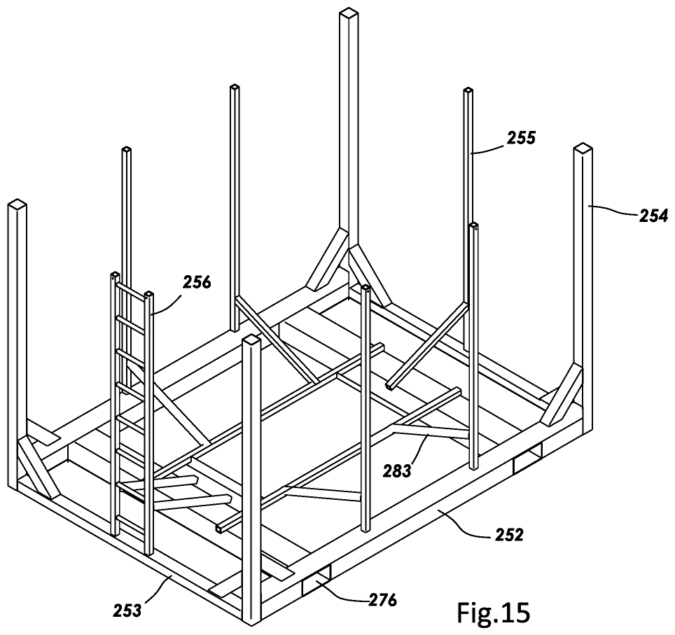

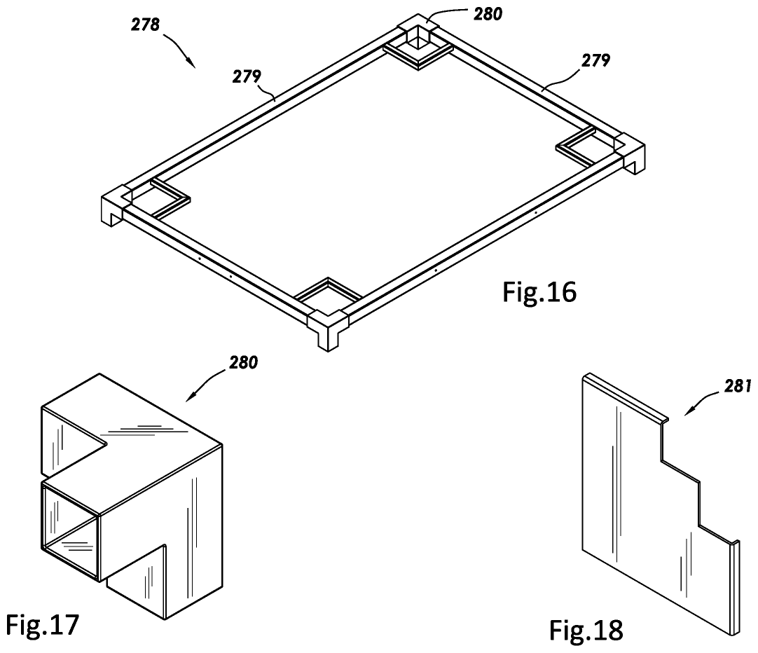

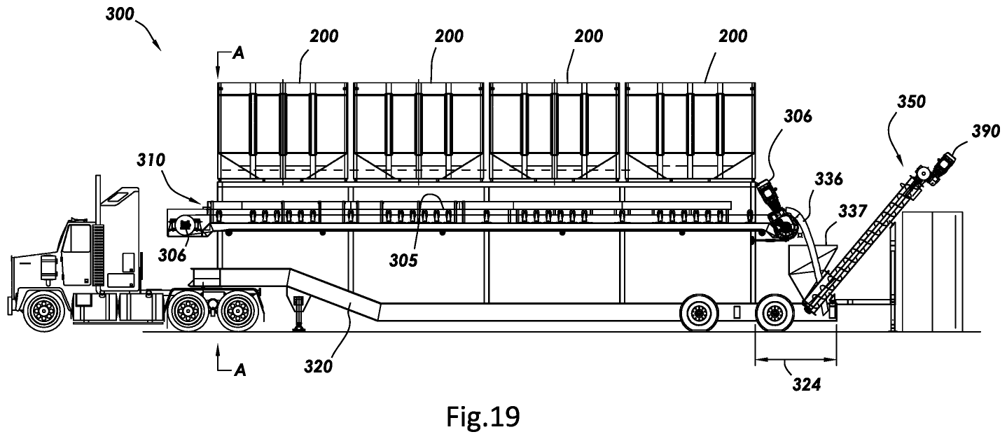

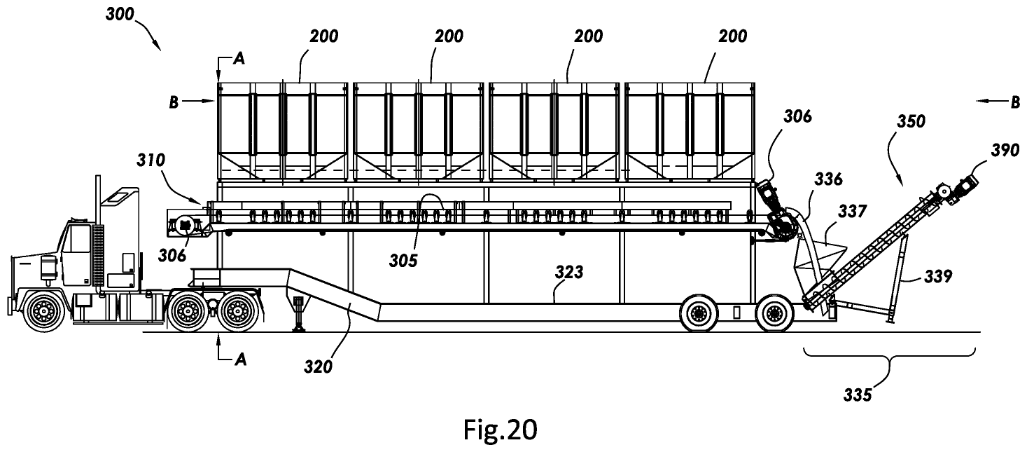

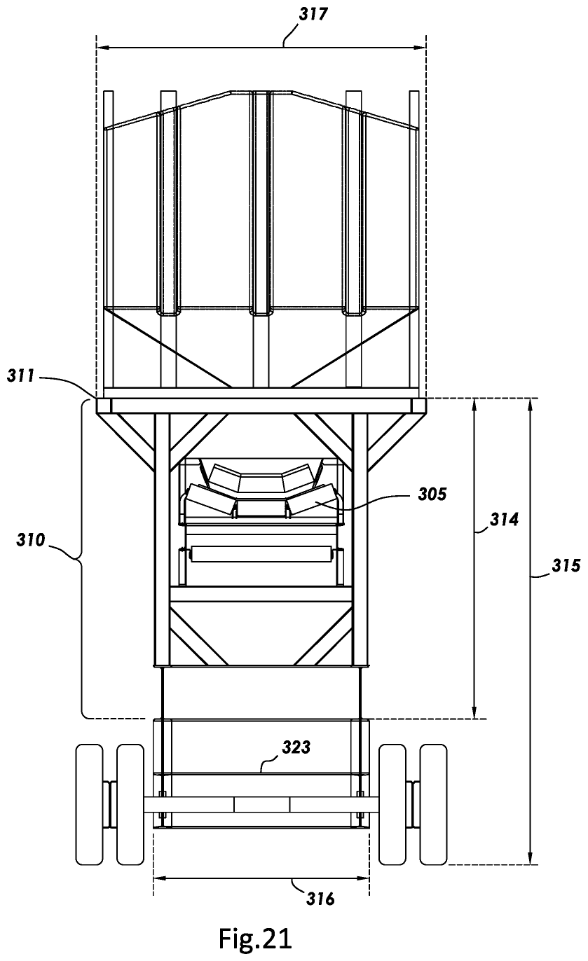

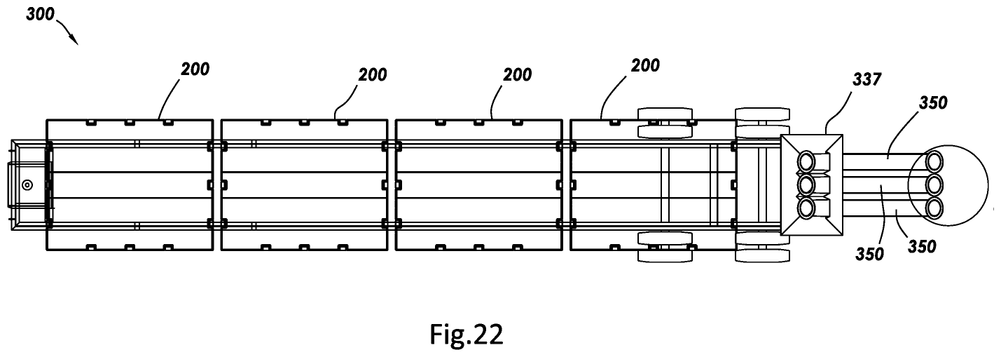

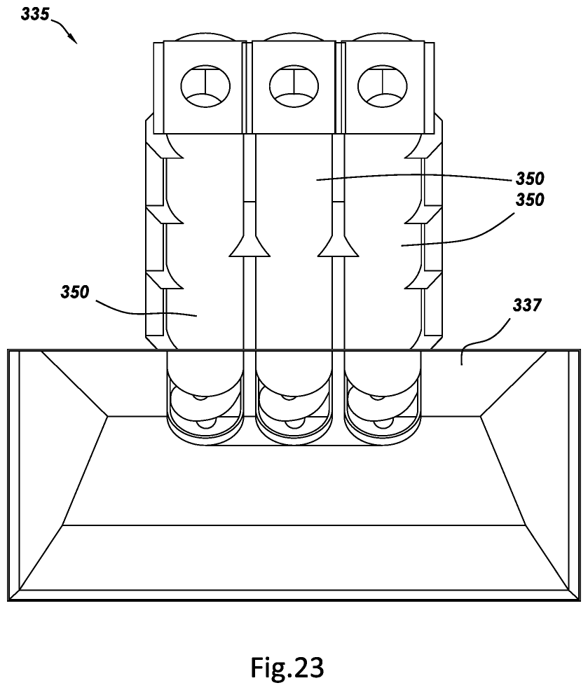

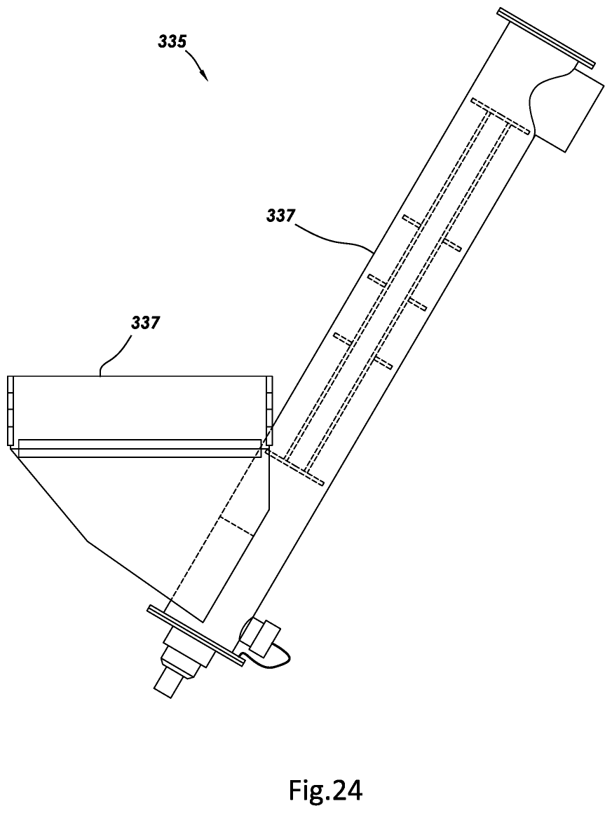

FIG. 5 is a front-end view of the proppant container of FIG. 4.

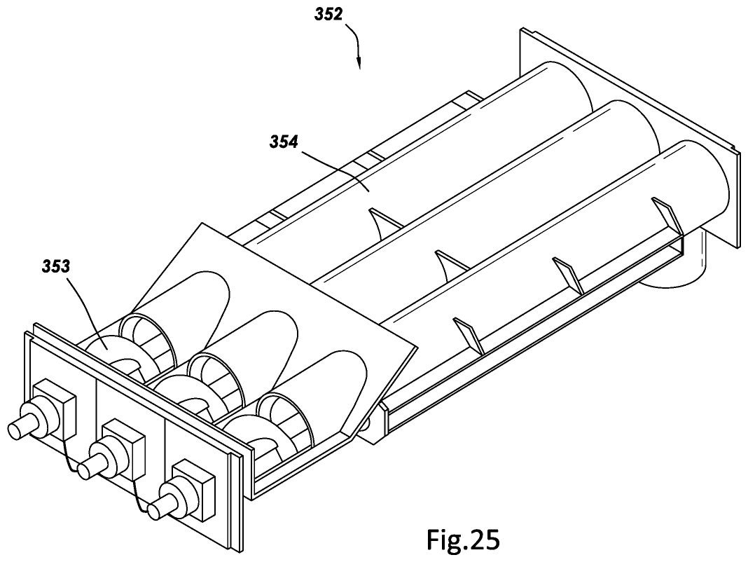

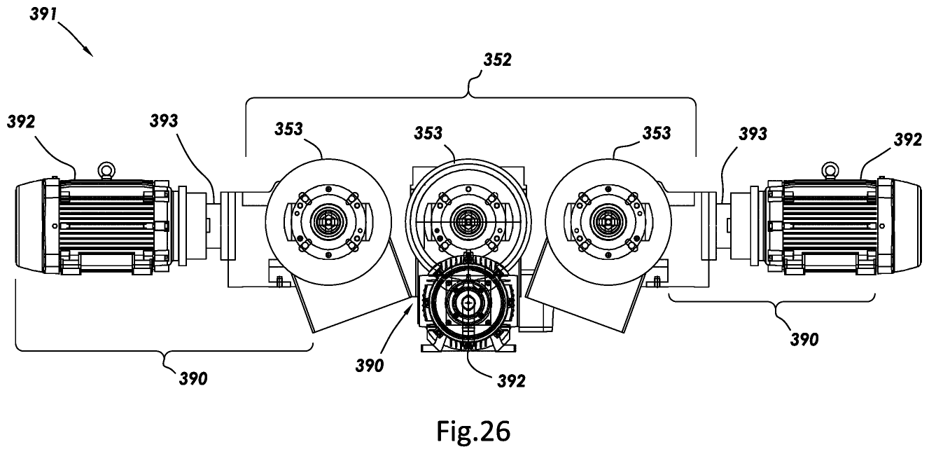

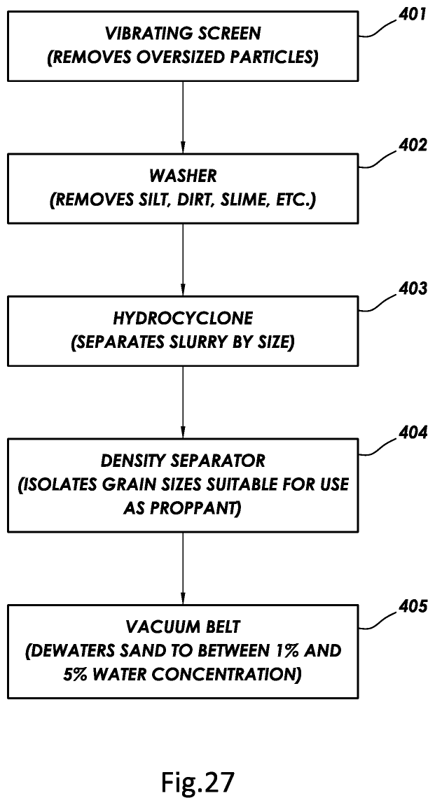

FIG. 6 is a view of the proppant container of FIG. 4 from the left or right side.

FIG. 7 is a front-end view of the proppant container of FIG. 4, revealing the height in inches of the container's different facet transitions.

FIG. 8 is a side view of the proppant container of FIG. 4, revealing the height in inches of the container's different facet transitions.

FIG. 9 is an interior view of a lower portion of the proppant container of FIG. 4, looking from the top.

FIGS. 10A, 10B and 10C are top, side, and handle-facing views, respectively, of one embodiment of a drop-bottom assembly for the container of FIG. 8.

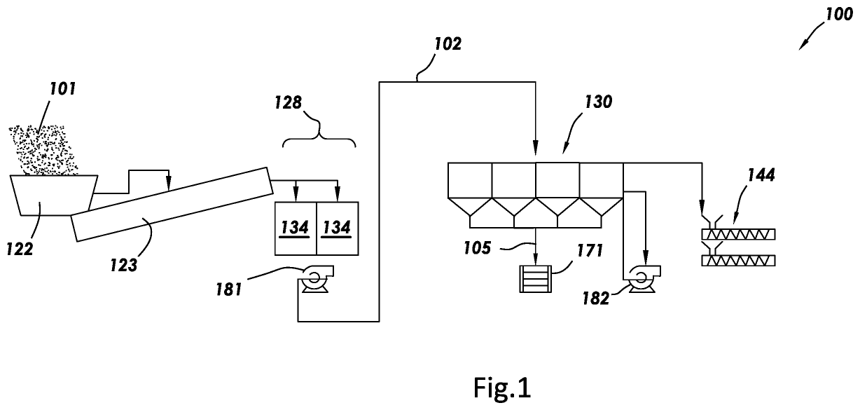

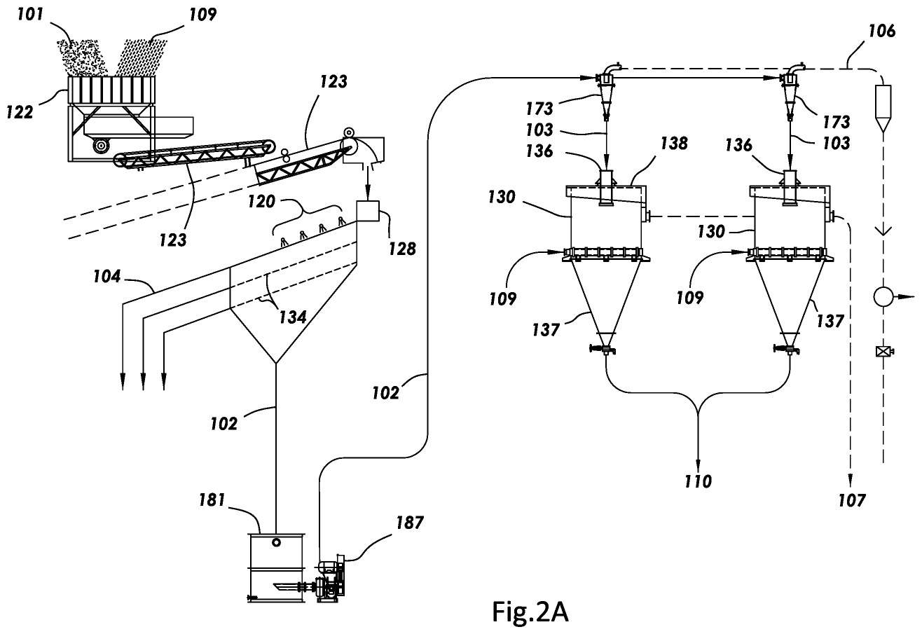

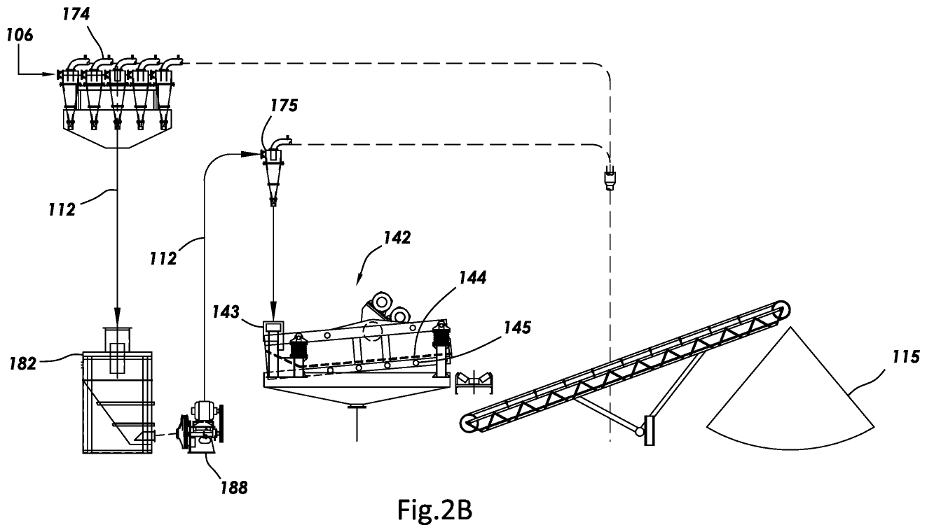

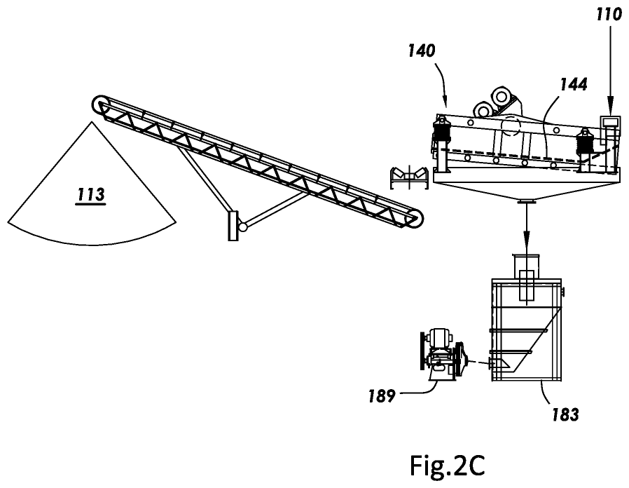

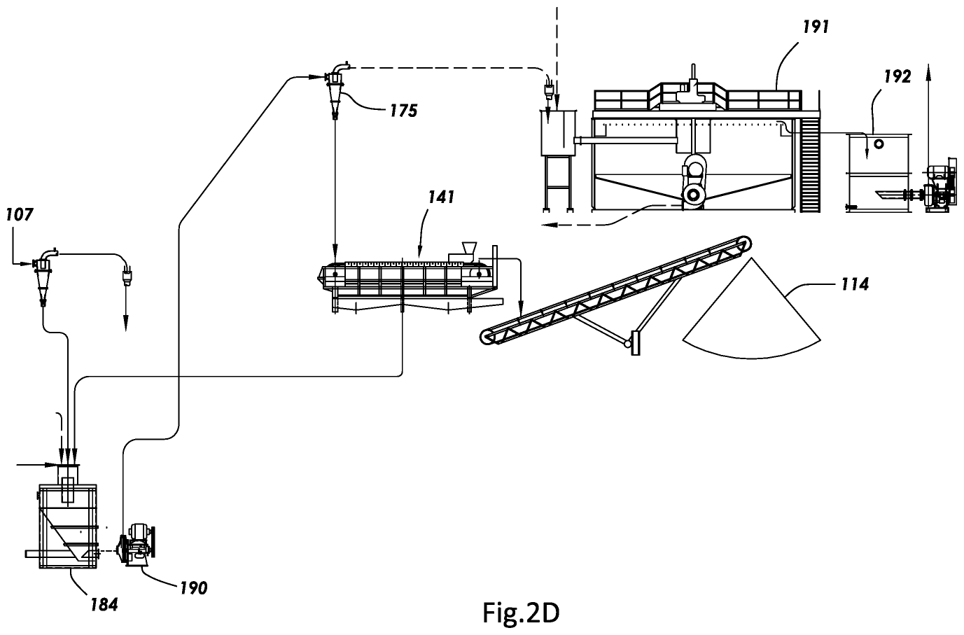

FIG. 11 is a perspective view of the frame of FIGS. 1 and 2.

FIG. 12 is a plan view of the top of the frame of FIG. 11.

FIG. 13 is a front-end view of the frame of FIG. 11.

FIG. 14 is a bottom view of the frame of FIG. 11.

FIG. 15 is a perspective view of a lower portion of the frame of FIG. 11 that includes the bottom and the sides of the frame.

FIG. 16 is a top perspective view of a top portion of the frame.

FIG. 17 is a top perspective view of a top corner fitting of the frame.

FIG. 18 is a perspective view of a corner plate of the frame.

FIG. 19 is a side view of one embodiment of a frac sand container trailer for shipping and delivering frac sand to an oil or gas well site.

FIG. 20 is another side view of the frac sand container trailer of FIG. 19.

FIG. 21 is a cross section along line A-A of FIG. 20, normal to the longitudinal axis of the truck, illustrating the arrangement of the proppant container and frame assembly over a multi-container carrier frame that also supports a conveyor belt.

FIG. 22 is a cross section along line B-B of FIG. 20, normal to the vertical axis of the truck.

FIG. 23 is a top view of a triple-auger embodiment of the proppant feeder.

FIG. 24 is a side view of the proppant feeder of FIG. 23.

FIG. 25 is a perspective view of the proppant feeder of FIG. 23.

FIG. 26 is a drawing of one embodiment of a screw drive that drives the augers of a three-auger embodiment of the frac sand container trailer.

FIG. 27 is a flow diagram of one embodiment of a process for preparing wet proppant suitable for shipping.

### DETAILED DESCRIPTION

Specific quantities (e.g., spatial dimensions) can be used explicitly or implicitly herein as examples only and are approximate values unless otherwise indicated. Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either both of those included limits are also included in the invention.

In describing preferred and alternate embodiments of the technology described herein, various terms are employed for the sake of clarity. Technology described herein, however, is not intended to be limited to the specific terminology so selected, and it is to be understood that each specific element includes all technical equivalents that operate similarly to accomplish similar functions. Where several synonyms are presented, any one of them should be interpreted broadly and inclusively of the other synonyms, unless the context indicates that one term is a particular form of a more general term.

In the specification and claims, conventionally plural pronouns such as “they” or “their” are sometimes used as non-gendered singular replacements for “he,” “she,” “him,” or “her” in accordance with emerging norms of pronoun usage. Also, although there may be references to “advantages” provided by some embodiments, other embodiments may not include those same advantages, or may include different advantages. Any advantages described herein are not to be construed as limiting to any of the claims.

Frac sand comprises grain sizes in a range suitable (for an intended oil or gas well) for use as proppants. For example, sand in which 90% of the particles will pass through an 8-mesh sieve having 2.38 mm openings and be retained by a 140-mesh sieve having 0.105 mm openings would be suitable for use in an oil or gas well operation requiring 8/140 sand (i.e., sand between 8-mesh and 140-mesh). Most oil and gas fracturing operations will have more specific requirements falling within this range.

Wet Frac Sand Plant

FIGS. 1 and 2 illustrate two embodiments of sand mine wet plants 100 for processing raw feed 101 comprising sand and other materials into proppant or proppants 113-115 suitable for use in a fossil fuel fracturing operation. Each wet mine plant 100 comprises one or more vibrating scalping screens 134, a washer 120, density separators 130, one or more dewatering screens 171, and one or more screen media 144. FIG. 1 is a single-page diagram of a basic sand mine wet plant 100 that produces a single size range of proppant. FIG. 2 is a four-page diagram of a more detailed sand mine wet plant 180 that generates up to three different size ranges of proppant. FIG. 2 is subdivided into four partial views—FIGS. 2A (top left), 2B (top right), 2C, (bottom left), and 2D (bottom right)—that form a complete diagram of a sand mine wet plant 100. In general, FIG. 2A illustrates, at a high level, a first half of the wet plat prior to dewatering screens, vacuum belts, and ultrafine recovery paths. FIG. 2B illustrates an ultrafine recovery path. FIG. 2C illustrates a dewatering screen path. And FIG. 2D illustrates a vacuum belt path.

A raw feed 101 of sand that, in a typical operation, has been mined from a deposit (such as a lakebed), is dumped or deposited on a belt feeder 122 and transported via conveyors 123. The sand travels along the feed conveyor 123, water is added, creating a raw feed slurry that accumulates in a wet box 128. The raw feed slurry passes from the wet box 128 onto a vibrating 30-mesh (0.84 mm) scalping screen 134 that separates sand and other particles less than about 0.8 mm (or about ⅘ mm) from sand, gravel, large rocks, wood, and debris that are too large to pass through the screen 134. The oversize material 104 is either recycled, dumped or redirected to other processing equipment to separate out bottle sand, concrete sand, pebbles gravel, and rocks suitable for other uses. Meanwhile, a washer 120 washes the raw feed slurry to remove impurities, including any dirt, organics, and clays. A sump 181, operated by a heavy duty slurry pump 187, carries the slurry 102 to the density separators 130 or to primary cyclones 173 that precede them.

In the embodiment of FIG. 1, density separators 130 receive the slurry 102. The underflow from the density separators 130—representing larger size proppant—is directed to dewatering screens 171. The overflow from the density separators 130—representing smaller and less dense particles—is pumped via sump pump 182 to dewatering media, filter or screens 144.

In the embodiment of FIG. 2, the filtered feed 102 enters a first set of hydrocyclones 173 (FIG. 2A). The 140-mesh or smaller proppant that is part of the hydrocyclone overflow 106 is gravity-fed or otherwise transported to a second bank of hydrocyclones 174 (FIG. 2B). The hydrocyclone underflow 103 (FIG. 2A), which consists mostly of a 30-mesh (0.595 mm) to 140-mesh slurry (hereinafter referred to as “30/140 slurry”)—enters the top of the density separators 130 via central feed-wells 136. Process water 109 is injected near the bottom of the density separators 130 to agitate and lift up smaller and less dense particles (i.e., approximately 50/140 particles) and sweep them over a weir 138. This weir-swept 50/140 slurry 107 (i.e., 0.105 mm to 0.297 mm) is transported to a third hydrocyclone 175. Sump 184 collects the underflow of hydrocyclone 175 and pump 190 pumps the underflow to a vacuum belt 141 (FIG. 2D).

The coarser and denser particles are collected by underflow cones 137 and discharged as a density-separated 30/50 mesh proppant slurry 110 (i.e., between 0.297 mm and 0.595 mm). This slurry 110 is then delivered to a first dewatering station 140 (FIG. 2C) to dewater and partially dry the slurry 110 into a partially wet 20/50 proppant pile 113. The 30/50 pile consists essentially only (i.e., 90% or more of the solid matter of the slurry) of water and 30-50 mesh sand whose particles have diameters of between ¼ mm and ⅝ mm.

The second set of hydrocyclones 174 (FIG. 2B) filter the hydrocyclone overflow 106 through 270-mesh filters, leaving a 140/270 proppant slurry 112 (i.e., 0.053 mm to 0.105 mm) that is pumped via sump 182 and pump 188, gravity-fed or otherwise transported to a third dewatering station 142.

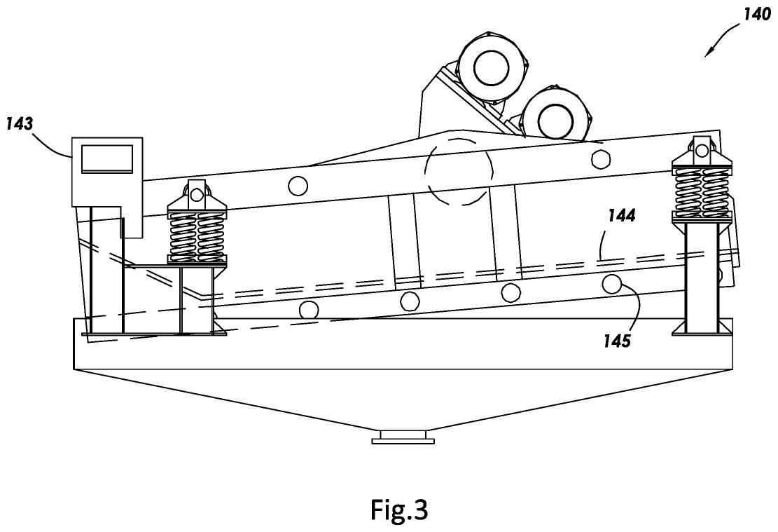

Each of the dewatering stations or screens 140 and 142 dewater and partially dry their respective 30/50, 50/140 and 140/270 slurries 110, 111 and 112 into partially wet proppant piles 113, 114 and 115. Each dewatering screen 140 and 142 (FIG. 3) comprises a cyclone 175, a feed box 143, a horizontal screen media 144, and a support deck 145. The cyclone 175 filters any remaining dirt or other too-small particulate matter from the incoming slurry 110, 111 or 112. A feed box 143 distributes the slurry evenly across the horizonal screen media 144. The horizontal screen media 144 is supported by the support deck 145, which generates high frequency vibrations, thus removing water from sand particles.

The slurry 110-112 is gradually deposited at one end of the dewatering station 140-142 through the feed box 143, and then slowly carried over the dewatering media, filter or screen 146 (need to show) that is mounted over a drainage grid, leaving a partially dry pile 113-115.

While vacuum belt 141 may be capable of removing substantially all of the moisture (i.e., moisture content of less than 1%), in the preferred embodiments the speed of the conveyor belt, the degree of vacuum pressure, the width and length of the conveyor belt, and/or the flow rate of the sand slurry onto the conveyor belt are selected and/or calibrated to deliver sand to a conveyor belt that has a moisture content of a targeted amount that is between 1% and 5%, by weight. At this weight range, the sand is dry enough to pump down a well hole, but not so wet that it adheres significantly to containers or boxes used to transport the proppant to the wellsite.

The hydrocyclones 173 can deliver their slurry 106 to either a vacuum belt 141 (an optional path not shown in FIG. 2) or a dewatering screen 142 (as shown in FIG. 2).

The wet sand plant 100 also provides a clarifier 191 and water storage tank 192 (FIG. 2D) to recycle process water 109 used in the operation of the plant 180.

FIG. 27 is a flowchart of a method of operation for the wet sand plant 100. It should be understood that the order in which these operations are conducted can in some cases be changed. In block 401, mined sand is wetted if needed and placed on a vibrating screen to remove branches, large pebbles or rocks, and other debris from the sand. In block 402, a pressure washer sprays the sand slurry to remove silt, dirt, slime, and the like. In block 403, a hydrocyclone divides the slurry into primary and secondary slurries, each having a different proppant size range. In block 404, a density separator further separates out a tertiary slurry, constituting a further differentiated size range, from the primary or secondary slurry. In block 405, each of the primary, secondary, and tertiary slurries are carried to a dewatering station, where the slurry is dumped onto a vacuum belt and then partially dried. Parameters for the vacuum pressure, vacuum belt speed, and dumping rate are configured to produce a wet proppant having between a 1% and 5% water concentration.

Delivery Container and Frame Assembly

FIGS. 4-18 illustrate a delivery container and frame assembly 200 for shipping wet proppant from a sand mine wet plant 100 or other proppant preparation plant to a fracturing site. The delivery container and frame assembly 200 comprises an aggregate container, or, more specifically, a proppant container 210 (FIG. 6) for holding the wet proppant and a structural, welded metal frame 250 (FIG. 11) enclosing the container 210.

In one embodiment, the container 210 is in the form of a molded plastic such as high-density polyethylene (HDPE). In another embodiment, the container 210 is a fiberglass container, metal container, wood container, or formed from some other synthetic material. In one implementation, the container 210 has a 11-12′ length 211, an 8-9′ width 212, and a 6-8′ height 213. In one very specific implementation, the container has a 141-¾″ length 211, a 101.5″ width 212, and a 95″ height 213. Also, one implementation of the container 210 has a low-slope pyramidic top 214, planar front and back exterior sides 216 and 217, planar left and right exterior sides 218 and 219, interior sand slides 233-241 (FIG. 9), and a sloped and multi-faceted bottom 220 resembling but less sloped than an upended mansard roof.

A hatch 228 (FIG. 7) is centered and hingedly connected to the top 214 of the container 210. In one implementation, that hatch 228 is configured to receive wet proppant dispensed from a wet plant 100 into the container 210. In another implementation, the size of the hatch 228 is configured to efficiently receive wet proppant dispensed from a frontloader. For example, the hatch may cover an opening in the top end whose area is greater than 576 in̂2. In yet another implementation, heavy earth moving equipment such as dump trucks can directly dump a load of wet proppant from a dock or dock-like structure into the container 210 through the hatch 228.

In practice, a loading dock will be elevated with respect to the container 210, which is carried by a forklift, a truck, or a train. The multi-faceted bottom 215 is configured to funnel wet sand through one or more knife or slide gates 275 mounted to the bottom of the molded plastic container 210. In one embodiment, two 10″-32″×10″-32″ side by side slide gates are provided to control the bottom opening.

Depending on the configuration of the wet plant, wet sand may be dispensed into the container 210 while the container 210 is seated on the ground, while it is mounted on a truck, or while it is mounted over a conveyor belt 305. It is preferred that the top hatch 228 and/or opening 247 (FIG. 6) covered by the hatch 228 form a rectangle having dimensions of at least 2′ by 7′ and an area of at least 14 sq. ft. In one embodiment, the hatch 228 and/or opening 247 forms a rectangle with a 30″ width 230 (FIG. 7) and a 102″ length 229 (FIG. 8), for a total area of 3060 sq. in. or 21-¼ sq. ft.

In one embodiment, the low-slope pyramidic top 214 has 6 facets (not including the opening 247 or the hatch 228), making it partially hip-roof-like and partially mansard-roof-like. This form of the container top 214 results in a more streamlined container than a box shape form. In one embodiment, the top 214 of the container 210 comprises lower left-side and right-side facets 223 (FIG. 7) that are oppositely oriented at 30° angles 249 from the horizontal and that extend about 15″ up the slope. Also, upper left-side and right-side facets 222 are oppositely oriented at 10° angles 248 to the horizontal and that extend about 23″ up the slope. Finally, front-end and back-end facets that are oppositely oriented at 30° angles from the horizontal and that extend about 23″ up the slope. In other embodiments, the container 210 may have different facets or no facets at all.

The interior sides (i.e., “sand slide”) of the bottom 215 of the molded plastic container are, in one implementation, made of the same material (e.g., HDPE) as the container 210 itself. In another implementation, at least the lower interior facets 233-241 of the container 210 are coated with a slippery, low-friction, hydrophobic substance such as graphite or polytetrafluoroethylene (PTFE+, both of which are readily commercially available). The application of these substances to the surface minimizes the adhesiveness of sand to the sloped bottom sides 233-241 of the container 210, making it easier to dispense the proppant. In yet another implementation, a thin layer of a solid with a low coefficient of friction, such as PVC or aluminum, is layered over the bottom 215 of the molded plastic container 210.

In general, it is preferred that the minimum slope angle of the container bottom facets 233, 234 be equal to or greater than the maximum angle of friction for wet sand on the container bottom 215. More specifically, this constraint is based on water densities of less than 5% (or other targeted water density, or where the standard deviation of water densities is within a threshold range of a targeted water density) and sand in the range of sizes generally suitable for use as proppants or specifically suitable for a particular oil and gas well site. Stated alternatively, a substance is selected for the interior surface of the container bottom facets 233-241 that has a coefficient of friction low enough so that the angle of friction between the sand and the interior surface is less than the interior bottom sides' slope angles 238, 241. At the same time, it is desirable that the slope angles 242-245 of the container bottom facets 233-241 be selected to maximize the container volume within the height, length, and width constraints of the container 210.

Accordingly, in one embodiment, the high slipperiness of the interior bottom sides 233-241 of the container 210 enable a construction with slope angles 242, 243 from the horizontal as low as 23° and 48° for the lower and upper sloped right-and-left side facets 233-237, respectively, of the container bottom 215. This embodiment also features 60° and 22° slope angles 244, 245 from the horizontal for the upper and lower front- and back-side facets 237-241, respectively, of the container bottom 215.

A drop bottom assembly 205, such as the one illustrated in FIG. 10, is mounted to the container bottom 215 to move a set of blades or slats 206 between open and shut positions. The drop bottom assembly 205 comprises a frame 225 including a flange 207, a hand crank 208, and a transmission (not shown). The flange 207 is configured to mount on the container bottom 215 around a container opening. The hand crank 208—or more preferably a remotely controlled motor (now shown)—is connected to the transmission (e.g., gear box and threaded rod) that is coupled to rotate the blades 206 between open and shut positions. In an alternative embodiment, a hatch or set of sliding gates or hinged doors replace the blades or slats. The hatch or set of gates may be configured for movement between a closed position parallel with the container bottom and an open position wherein the hatch or set of gates are rotated about an axis parallel to the bottom opening. In this implementation, the hatch or set of gates, when rotated between open and closed positions, traverse an opening in the bottom frame of the frame 250.

In one embodiment, the left and right sides 218, 219 and back end 217 of the container 210 also feature grooves or channels 221 (either characterization is apropos) for receiving, coupling or interlocking with braces, bars, or beams 255 (any of these characterizations is apropos) of the frame 250. The front side 216 also features a wide recess or channel 232 for receiving a ladder 256 that doubles as a brace. Furthermore, the corners 246 of the container 210 feature 90-degree angled furrows 246. These elements nest the container 210 between the vertical corner posts 254, the ladder 256, and a back post 255 of the frame 250, thereby securing the container 210 from forward, backward, rightward and leftward movement with respect to the frame 250.

The frame 250 is structural—and, in one embodiment, comprised of steel—including a bottom portion 251 (FIG. 5) that receives the container 210 and a top portion 278 that secures the container 210 within the frame 250. The bottom portion 251 comprises two longitudinal beams or girders 252, two transverse beams or girders 253, vertical corner posts 254, wall braces 255, a ladder 256, a central support assembly 270, and forklift slots 276 for receiving the tongs of a forklift. The longitudinal beams 252, vertical corner posts 254 and wall braces 255 are, in one implementation, formed from square tube, angle bar, or channel bar. In one embodiment, the vertical corner posts 254 are about 8½ feet in height 292 and extend all of the way from a lowermost point on the frame 250 to an uppermost point on the frame 250, and the wall braces 255 are about 7½ feet in length and extend from a point along a top of one of the bottom portion's longitudinal beams 252 to a bottom of one of the top portion's longitudinal beams 252. Overall, the frame 250 has a length 290 (FIG. 4) of about 12 feet, a width 291 of about 8½ feet, and a height 292 of about 8½feet.

In the illustrated embodiment, additional strength is provided by 4″×6″ rectangular tube reinforcement beams 277 placed under the bottom portion's longitudinal beams 251 and between the vertical corner posts 254 and forklift slots 276.

The central support assembly 270 supports the drop bottom assembly 205. The central support assembly 270 comprises two longitudinal support rods 271 spaced apart by an amount that is approximately equal to the width of the container's bottom opening (not shown) and welded or mechanically coupled to the forklift slots 276. The central support assembly 270 further comprises two transverse support rods 269 that are welded or mechanically coupled to the assembly's longitudinal support rods 271. Finally, the central support mount assembly 270 comprises a plurality of diagonal braces 283 that are welded or mechanically coupled to the assembly's longitudinal support rods 252 and the bottom portion's wall braces 255, ladder 256, and forklift slots 276. The drop bottom assembly 205 mounted to the underside of the container 210.

The top portion 278 (FIGS. 5, 16) comprises four rectangularly-arranged side beams 279, corner connectors 280, and corner cap plates 281 (FIG. 11, 18). The corner connectors 280 connect the side beams 279 together and tie the top portion 278 to the vertical corner posts 254 of the bottom portion 251. The corner cap plates 281, which are attached to the top portion 278 of the frame 250 after the container 210 is inserted into the frame 250, secure the container 210 against vertical movement with respect to the frame 250.

The delivery container and frame assembly 250 is configured to be assembled by placing the bottom frame 251 on a supporting surface, inserting the molded plastic container 210 between vertical braces 254 of the bottom frame 251, seating the molded plastic container 210 on supporting members of the bottom frame 251, and attaching the top frame 278 to the bottom frame 251. The joints between the various frame components may be welded, bolted, or otherwise connected. Once assembled, the delivery container and frame assembly 270 preferably has an overall width 212 (FIG. 13) of no greater than 102 inches.

Advantageously, the wet sand delivery and conveyor apparatus 300 enables wet sand to be carried directly from a wet plant 100 to an oil and gas fracking operation. Combined with the improvements to the wet plant 100 and containers 210, the apparatus 300 circumvents the need for a dry plant to desiccate the sand.

Wet Sand Delivery and Conveyor Apparatus

FIGS. 19-22 illustrate a wet sand delivery and conveyor apparatus 300 (which may be more broadly referred to as a mobile proppant conveyor apparatus) for shipping wet proppant 113-115 from a sand mine wet plant 100 to a well fracturing site and delivering the wet proppant directly to the well site. The wet sand delivery and conveyor apparatus 300 comprises a multi-container support frame 310 configured to be mounted on a trailer bed 323, a plurality of containers 210—preferably enclosed within delivery container and frame assemblies 200—mounted to or on an upper portion of the frame 310, and one or more conveyor belts 305 mounted on the frame below the plurality of containers 210 and positioned to receive proppant released in a gravity pour from the containers 210 onto the conveyor belt 305. A proppant feeder 335, which preferably includes an auger 350, is mounted near an end of the conveyor belt 305 to transfer sand from the end of the trailer bed 323 to a position extending diagonally upward and away from the trailer bed 323 to drop sand into a vessel or sand deposit site positioned underneath an upper end portion of the auger 350.

The multi-container support frame 310 is mounted on a bed 323 of a semitruck trailer 320 and extends along most of its length. A small end portion 324 of the trailer 320, about 8-9 feet in length, is reserved to support the hopper 337 and auger 350. The support frame 310 carries a plurality of proppant container and frame assemblies 200 mounted on and along the top 311 (FIG. 21) of the multi-container support frame 310.

The conveyor belt or belts 305 are mounted inside the frame 310 below the plurality of containers 210 and are positioned to receive wet proppant dropped from the containers 210 above. One or two remotely controllable belt drive(s) 306 are mounted at one or both of the ends of the conveyor belt 305 to run the conveyor belt(s) 305. Remotely controllable drop bottom assembly actuators (not shown) operate the knives, slats, gates, or doors to dump wet proppant onto the conveyor belt 305. In the implementation illustrated in FIG. 21 (which is a vertical cross section along line A-A of FIG. 20), a longitudinally extending center belt 305 is flanked by right and left side belts slanted toward the center belt. This arrangement minimizes spillage of proppant over the sides. In one implementation a single conveyor belt 305 constitutes a center section and two wings that are folded up from the center section.

Attached to the end of the frame is a proppant feeder 335, which comprises a chute 336 and a hopper or funnel 337 configured to receive wet sand coming off of the conveyor belt 305, and an auger 350 configured to deliver and lift up a metered flow rate of wet sand to a storage site), vehicle, or facility (e.g., a conveyor belt or blender) at an oil or gas site. The conveyor belt 305 carries the wet proppant to an endpoint of the belt 305, where the wet proppant rolls off the conveyor belt 305 in a gravity pour through the chute 336 and into the hopper or funnel 337. The screw drive 390 drives an auger 350 to carry the wet proppant beyond the end of the truck and upward. The auger 350 is long enough to deposit the sand at a fracturing sand storage site or onto a truck or onto an oil or gas site conveyor belt or vessel positioned underneath an upper end portion of the auger 350. As illustrated by FIGS. 19 and 20, a hydraulic lift 339 controllably rotates the auger 350 about a trailer-mounted axis between a retracted position suitable for transport and an extended position above a vessel or sand deposit site. The angle of the auger 350 with respect to the ground is adjustable.

FIG. 22 is a top cross-sectional view along B-B of FIG. 20. This view illustrates the wet proppant delivery and conveyor apparatus 300 as incorporating a triple-auger embodiment of the proppant feeder 335. FIGS. 23, 24, and 25 provide top, side, and perspective views of the triple-auger proppant feeder 335. The conveyor belts 305 dump proppant into a chute 336 and hopper 337 mounted near the end of the trailer bed 323. The hopper 337 is configured to split the proppant flow into three approximately equal flows where it received by a set of three augers 350. Each auger 350 is, in one conception, between 7 and 11 feet in length and in one implementation, about 9 feet, and carries the sand along an upward diagonal trajectory until it can be dumped into a well, or a hopper or blender apparatus of the well, at an oil and gas site. FIG. 25 is a perspective view of the conveyor unit 352 of the drive assembly 391, which contains three auger/screw conveyors 353, each of which is mounted within a sleeve or sleeve-like tube 354 to maximize conveyance of the proppant.

As shown in FIG. 21, the top 311 of the multi-container support frame 310 extends a height 314 about ten feet above the bed 323 of the trailer 320, and a height 315 of about fifteen feet above the ground. Along most of its vertical length, the multi-container support frame 310 has a road-worthy width 316 of about eight feet. But in the top foot or so, the multi-container support frame 310 widens out to a width 317 about nine feet in order to support the full width of each of the delivery container and frame assemblies 200. In an alternative implementation, the frame 310 is miniaturized along the vertical dimension so that the entire semitruck and load, including the frame 310 and containers mounted on the frame, meet federal regulations limiting how wide and tall a vehicle can be without having to comply with “oversized load” requirements. The dimensions and specifications associated with these regulations are herein incorporated by reference.

FIG. 26 illustrates one embodiment of a triple screw drive assembly 391 that drives the three augers 350 of the triple-auger embodiment of the proppant feeder 335. The triple screw drive assembly 391 comprises three screw drives 390, each of which comprises a drive motor 392 and a transmission 393. Each of the screw drives 390 is coupled to a corresponding auger/screw conveyor 353 of the conveyor unit 352. In the right and left screw drives 390, the transmission 393 converts rotary motion along a lateral axis to rotary motion of its corresponding auger/screw conveyor 353 along a perpendicular longitudinal axis. The middle drive motor 392 gears to the middle screw drive 390, generating rotary motion of the middle auger/screw conveyor 353 along a parallel longitudinal axis to the motor rotor. In one embodiment, the middle conveyor 353 is driven at a higher rate of speed and proppant displacement rate than the right and left conveyors 353. The differences in the rates are either tuned manually or automatically determined based upon sensory information about the distribution of proppant across the hopper 337.

In a preferred embodiment, any or all of the actuators are remotely controllable. Thus, in one implementation, on operator on the ground can use a single remote controller to operate the drop bottom assemblies 205 of each container 210, the speed of the belt drives 306 driving the conveyor belt(s) 305, the speed and volume of the auger(s) 350, and/or the lift 339.

Conclusion

As will be appreciated, the present disclosure reveals several inventions, all of which combined serve the purpose of making the production, transport, and use of wet proppant feasible.

In one invention or inventive aspect, a sand mine wet plant for processing raw feed comprising sand and other materials into proppant suitable for use in a fossil fuel fracturing operation is provided. The wet mine comprises a washer, a density separator, and a vacuum belt. The washer washes the raw feed to remove impurities, including any debris, dirt, organics, clays, from the raw feed. The density separator that receives the washed sand separates out other materials—including pea gravel, bottle sand, concrete sand, and/or gravel—in the washed feed and further separates sand having grain sizes in a range suitable for use as proppants in the fossil fuel fracturing operation from sand whose grain sizes are outside the range. The vacuum belt removes a sufficient amount of water from the slurry to reduce the moisture content to below 5%.

In another invention or inventive aspect, a delivery container and frame assembly for shipping wet proppant from a sand mine wet plant to a fracturing site is provided. The delivery container and frame assembly comprises a molded plastic container for holding the sand having a top end, front and back exterior sides, left and right exterior sides, interior sand slides, and a sloped bottom configured to funnel wet sand out in a gravity pour; and a high-strength rigid structural frame enclosing the molded plastic container.

The containers are equipped with drop bottom assemblies to release sand from the container. The drop bottom assemblies are mounted on a bottom region of the structural frame underneath the molded plastic container. The drop bottom assemblies comprise blades, slats, gates, or doors, or equivalent mechanisms that either slide or pivot between open and closed positions.

The molded plastic container is configured with multiple facets to maximize load capacity while minimizing the amount of sand that continues to sit on or stick to the bottom and side surfaces. The sloped bottom of the molded plastic container is pitched at an angle as least as great as an angle of friction of the wet proppant on the sloped bottom. Also, a hatch is pivotally attached to the top end of the molded plastic container.

The structural frame comprises a bottom frame and a top frame. The delivery container and frame assembly is configured to be assembled by placing the bottom frame on a supporting surface, inserting the molded plastic container between vertical braces of the bottom frame, seating the molded plastic container on supporting members of the bottom frame, and attaching the top frame to the bottom frame. Overall, the structural frame is dimensioned to not exceed federal commercial trailer regulatory maximum size limits of 102 inches wide.

The structural frame further comprises braces that are seated within channels molded into the left and right exterior sides of the molded plastic container, which secures the molded plastic container against forward and backward movement with respect to the structural frame. Braces and/or ladders may be seated within channels molded into the front and back sides of the molded plastic container, which secure the molded container against side-to-side movement with respect to the structural frame. The structural frame is also equipped with slots for receiving tongs of a forklift vehicle. The structural frame may further comprise corner plates configured to be assembled with the top frame.

In the invention or inventive aspect that is the focus of this application, a wet sand delivery and conveyor apparatus for shipping wet proppant from a sand mine wet plant to a well fracturing site and delivering the wet proppant directly to the well site is provided. The wet sand delivery and conveyor apparatus comprises a multi-container support frame configured to be mounted on a trailer bed, a plurality of containers (and their enclosing frames, if any) mounted to an upper portion of the frame, and a conveyor belt mounted on the frame below the plurality of containers and positioned to receive proppant released in a gravity pour from the containers onto the conveyor belt. The wet sand delivery and conveyor apparatus preferably further comprises one or more augers mounted near a dispensing end of the conveyor belt or rear end of the trailer bed, and supported by the trailer bed or multi-container support frame, to transfer sand from the end of the trailer bed to a position extending diagonally upward and away from the trailer bed to drop sand into a vessel or sand deposit site positioned underneath an upper end portion of the auger.

In various implementations, a lift controllably rotates the auger about a trailer-mounted axis between a retracted position suitable for transport and an extended position above the vessel or sand deposit site. A total of three augers are mounted near the end of the conveyor belt, all of which augers are configured to carry the sand and drop the sand into the vessel or sand deposit site. A proppant feeder is positioned at an end of the frame that receives and offloads sand carried by the conveyor belt. The feeder, in one embodiment, comprises a hopper that collects the sand to be delivered. It may also comprise a chute or funnel, a top of which is positioned at a level that is below the conveyor belt, and a bottom of which feeds into the hopper. Preferably, for each container carried by the multi-container frame, the drop bottom assembly is remotely controllable.

Having thus described exemplary embodiments of the present invention, it should be noted that the disclosures contained in the drawings are exemplary only, and that various other alternatives, adaptations, and modifications can be made within the scope of the present invention. Accordingly, the present invention is not limited to the specific embodiments illustrated herein but is limited only by the following claims.

I claim:

1. A wet sand delivery and conveyor apparatus for shipping wet proppant from a sand mine wet plant to a well fracturing site and delivering the wet proppant directly to the well site, the wet sand delivery and conveyor apparatus comprising:
a multi-container support frame configured to be mounted on a trailer bed;
a plurality of containers mounted to an upper portion of the frame;
a conveyor belt mounted on the frame below the plurality of containers and positioned to receive proppant released in a gravity pour from the containers onto the conveyor belt.

2. The wet sand delivery and conveyor apparatus of claim 1, further comprising an auger mounted near an end of the trailer bed and supported by the trailer bed to transfer sand from the end of the trailer bed to a position extending diagonally upward and away from the trailer bed to drop sand into a vessel or sand deposit site positioned underneath an upper end portion of the auger.

3. The wet sand delivery and conveyor apparatus of claim 2, further comprising a lift that controllably rotates the auger about a trailer-mounted axis between a retracted position suitable for transport and an extended position above the vessel or sand deposit site.

4. The wet sand delivery and conveyor apparatus of claim 2, wherein a total of three augers are mounted near the end of the conveyor belt, all of which augers are configured to carry the sand and drop the sand into the vessel or sand deposit site.

5. The wet sand delivery and conveyor apparatus of claim 1, further comprising one or more belt drives mounted on one of or both the ends of the support frame.

6. The wet sand delivery and conveyor apparatus of claim 1, further comprising a feeder positioned at an end of the frame that receives and offloads sand carried by the conveyor belt.

7. The wet sand delivery and conveyor apparatus of claim 1, wherein:
each of the plurality of containers is equipped with a drop bottom assembly to release sand from the container; and
the drop bottom assembly comprises blades, slats, gates, or doors that either slide or pivot between open and closed positions.

8. A wet sand delivery and conveyor apparatus comprising:
a multi-container support frame;
a plurality of sand containers mounted on the support frame configured to carry wet sand suitable for use as a proppant; and
a conveyor belt positioned beneath the plurality of sand containers to receive sand released from the sand containers.

9. The wet sand delivery and conveyor apparatus of claim 8, further comprising a feeder positioned at an end of the frame that receives and offloads sand carried by the conveyor belt.

10. The wet sand delivery and conveyor apparatus of claim 9, wherein the feeder comprises a hopper that collects the sand to be delivered.

11. The wet sand delivery and conveyor apparatus of claim 10, wherein the proppant feeder comprises a chute or funnel, a top of which is positioned at a level that is below the conveyor belt, and a bottom of which feeds into the hopper.

12. The wet sand delivery and conveyor apparatus of claim 9, wherein the proppant feeder includes an auger that offloads the sand.

13. The wet sand delivery and conveyor apparatus of claim 12, wherein the auger carries the sand collected by the hopper up to a position that extends away from and above the hopper.

14. The wet sand delivery and conveyor apparatus of claim 9, further comprising a plurality of augers that offload the sand.

15. The wet sand delivery and conveyor apparatus of claim 8, wherein:
each of the plurality of sand containers is equipped with a drop bottom assembly to release sand from the container; and
the drop bottom assembly comprises blades, slats, gates, or doors that either slide or pivot between open and closed positions.

16. The wet sand delivery and conveyor apparatus of claim 15, wherein for each container carried by the multi-container frame, the drop bottom assembly is remotely controllable.

17. A multi-container transport frame for transporting sand suitable for use as a proppant, the transport frame comprising:
a lower section configured to mount the transport frame to a trailer bed;
a middle section configured to operably support a conveyor belt extending along a length dimension of the transport frame; and
an upper section configured to brace a plurality of sand containers that carry sand suitable for use as a proppant.

18. The multi-container transport frame of claim 17, further comprising a rear section that supports a portion of a proppant feeder that unloads sand from the conveyor belt.

19. The multi-container transport frame of claim 17, wherein the upper section has a width that is greater than a width of the lower section.

20. The multi-container transport frame of claim 17, wherein the middle section is also configured to operably support a plurality of conveyor belts that are arranged side-by-side along a length of the trailer bed, with the conveyor belts positioned to the right and left of a middle conveyor belt are angled toward the middle conveyor belt to bias sand toward the middle conveyor belt.
